(19) United States
(12) Patent Application Publication
(10) Pub. No.: US 2006/0015595 A1
(43) Pub. Date: Jan. 19, 2006

(54) Method and apparatus for obtaining addresses for multiple interfaces in a device

(75) Inventors: G. Shantala, Austin, TX (US); Vasu Vallabhaneni, Austin, TX (US); Patrick T. Vo, Houston, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/870,524

(22) Filed: Jun. 17, 2004

(51) Int. Cl. G06F 15/177

(52) U.S. Cl. 709/222

(57) ABSTRACT

The present invention provides a method and apparatus for obtaining addresses for multiple interfaces in a device. The method comprises generating a message and transmitting the message to a server over a communication link. The message includes a request for a server to provide a first address to assign to a first interface of a client device and a second address to assign to a second interface of the client device. The method further comprises receiving a response from the server configuring at least one of the first interface and second interface based on the response received from the server. The response includes the first address and the second address.

### BACKGROUND OF THE INVENTION

1. Field of the Invention

The invention generally relates to network communications, and, in particular, to obtaining addresses for multiple interfaces in a device.

2. Description of the Related Art

The Dynamic Host Configuration Protocol (DHCP) describes how Internet Protocol (IP) addresses can be dynamically assigned to devices on a network. DHCP allows static and dynamic IP addresses to coexist. Dynamic addressing simplifies network administration because the software keeps track of IP addresses rather than requiring an administrator to manage the task. This means that a new computer can be added to a network without the hassle of manually assigning it a unique IP address. One version of DHCP for IPv6 is described in Request For Comments (RFC) 3315, entitled “Dynamic Host Configuration Protocol for IPv6,” dated July 2003, which is incorporated by reference in its entirety.

It is not uncommon for a “multi-homed” host to utilize the DHCP to obtain a plurality of addresses from a DHCP server. A multi-homed host may be, for example, a computer that has multiple network cards that are connected to multiple data links that are on the same or different networks.

On a multi-homed host intending to perform dynamic configuration for more than one interface, the conventional configuration method requires that each interface be configured individually. As such, the multi-homed host needs to have one state machine per each interface and hence one session per interface with the server. However, requiring a separate session to configure each interface can be inefficient, particularly as the number of interfaces on a given multi-homed host increases.

The present invention is directed to addressing, or at least reducing, the effects of, one or more of the problems set forth above.

### SUMMARY OF THE INVENTION

In one aspect of the instant invention, a method is provided for obtaining addresses for multiple interfaces in a device. The method comprises generating a message and transmitting the message to a server over a communication link. The message includes a request for a server to provide a first address to assign to a first interface of a client device and a second address to assign to a second interface of the client device. The method further comprises receiving a response from the server configuring at least one of the first interface and second interface based on the response received from the server. The response includes the first address and the second address.

In another aspect of the instant invention, a server is provided. The server includes an interface communicatively coupled to a control unit. The control unit is adapted to receive a message from a client and transmit a response to the client. The message includes a request to provide a first address for assignment to a first interface of the client and a second address for assignment to a second interface of the client. The response including the first address and the second address

In another aspect of the instant invention, an article comprising one or more machine-readable storage media containing instructions is provided for obtaining addresses for multiple interfaces in a device. The instructions, when executed, enable a processor to generate a message requesting a server to provide a first address to assign to a first interface of a client device and a second address to assign to a second interface of the client device, transmit the message to the server and receive a response from the server. The response includes the first address and the second address and further includes configuring at least one of the first interface and second interface based on the response received from the server.

In another aspect of the instant invention, a client device is provided for obtaining addresses for multiple interfaces in a device. The client device comprises at least a first interface and a second interface and a control unit. The control unit is adapted to generate a message requesting a server to provide a first address to assign to the first interface of a client device and a second address to assign to the second interface of the client device, transmit the message to the server and receive a response from the server. The response includes the first address and the second address and further includes configuring configure at least one of the first interface and second interface based on the response received from the server.

In another aspect of the instant invention, a message structure is provided. The message structure comprises a first field for identifying a type of message and a second field that includes a first interface option for providing configuration information associated with a first interface of a client. The configuration information includes a type of address desired for the first interface and a second interface option for providing configuration information associated with a second interface of the client. The configuration information includes a type of address desired for the second interface.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system, in accordance with the present invention.

FIG. 2 illustrates a format of a DHCP message that may be employed in the communications system of FIG. 1, in accordance with one embodiment of the present invention.

FIG. 3 depicts an option field that may be implemented in the DHCP message of FIG. 2, in accordance with one embodiment of the present invention.

FIG. 4 illustrates the DHCP message of FIG. 2 that includes the option field of FIG. 3 for configuring multiple interfaces, in accordance with one embodiment of the present invention.

FIG. 5 depicts a flow chart of one aspect of the client module of FIG. 1 is illustrated, in accordance with one embodiment of the present invention.

FIG. 6 illustrates a block diagram of a processor-based device that may be employed in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

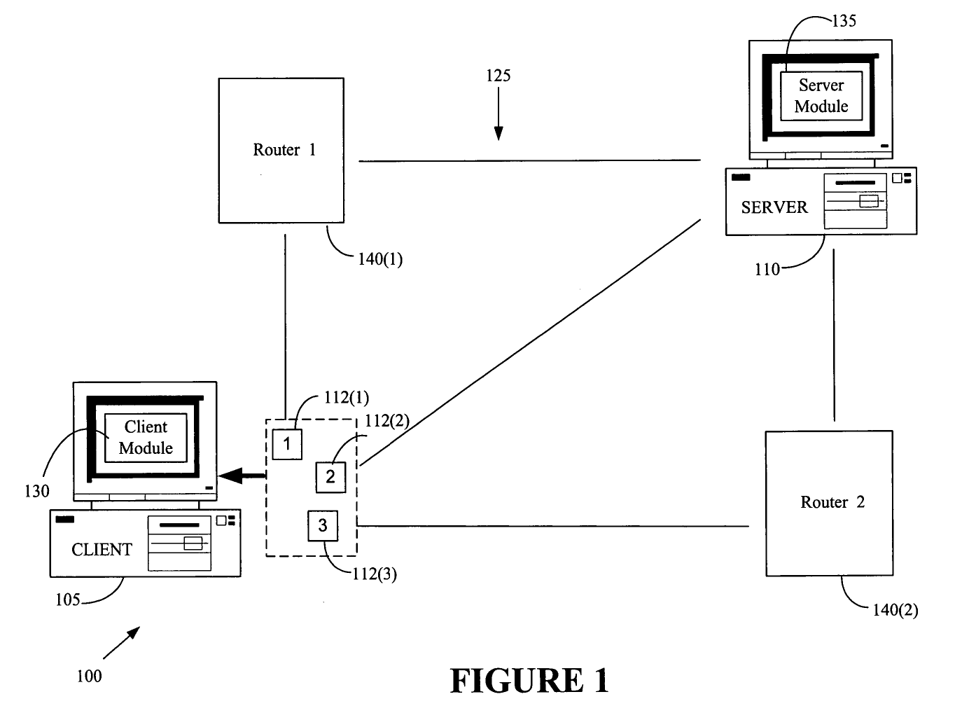

Referring to FIG. 1, a communications system 100 is illustrated in accordance with one embodiment of the present invention. The communications system 100 includes a first processor-based device (a multi-homed host) 105 that is capable of being communicatively coupled to a second processor-based device (a server) 110 by a plurality of interfaces 112 over a network 125, such as a private network or a public network (e.g., the Internet). In the illustrated embodiment, the multi-homed host 105 includes three interfaces 112(1-3), although in alternative embodiments other number of interfaces may also be employed. In one embodiment, each interface 112 may be a network adapter, such as an Ethernet network adapter.

The network 125 of FIG. 1 may be a packet-switched data network. In the illustrated embodiment, the network 125 is a data network according to the Internet Protocol/Transport Control Protocol (TCP/IP) and/or User Datagram Protocol (UDP). Examples of the network 125 may include local area networks (LANs), wide area networks (WANs), intranets, and the Internet. One version of IP is described in Request for Comments (RFC) 791, entitled “Internet Protocol,” dated September 1981, and a version of TCP is described in RFC 793, entitled “Transmission Control Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. A version of UDP is described in RFC 768, entitled “User Datagram Protocol,” dated August 1980. The data network 125 may also include other types of packet-based data networks in further embodiments. Examples of such other packet-based data networks include Asynchronous Transfer Mode (ATM), Frame Relay networks and the like.

In the illustrated embodiment, the server 110 is a Dynamic Host Configuration Protocol (DHCP) server that assigns addresses requested by clients, such as the multi-homed host 105. As described in greater detail below, the multi-homed host 105 includes a client module 130 that, in accordance with one embodiment of the present invention, configures a plurality of interfaces 112 in an efficient manner such that one session for each interface 112 to be configured is not needed. The client module 130 communicates with a module 135 of the server 110. For illustrative purposes, it is herein assumed that the server 110 operates in accordance with DHCP for IPv6, as described in RFC 3315.

In the illustrated embodiment, the multi-homed host 105 and server 110 communicate using DHCP messages. In the illustrated embodiment, the multi-homed host 105 uses a link-local address or addresses determined through other mechanisms for transmitting and receiving DHCP messages. The server 110 may receive messages from the multi-homed host 105 using a link-scoped multicast address.

The network 125 may include one or more network routers 140(1-2) through which the multi-homed host and server 105, 110 may communicate. The number of routers 140(1-2) employed in a given network 125 may vary from one implementation to another, even though only two are shown in FIG. 1.

In the illustrated embodiment of the communications system of FIG. 1, the first interface 112(1) shares the same prefix (e.g., belongs to the same subnet) as the first router 140(1), the second interface 112(2) shares the same prefix as the server 110, and the third interface 112(3) shares the same prefix as the second router 140(2). As such, in the illustrated embodiment, the first interface 112(1) communicates with the server 110 via the first router 140(1), the second interface 112(2) communicates directly with the server 110, and the third interface 112(3) communicates with the server 110 via the second router 140(2). To allow the interface 112 of multi-homed host 105 to send a message to the server 110 that is not attached to the same link, a DHCP relay agent may be present at an intermediate node, such as the router 140. The relay agent may relay messages between the interface 112 and the server 110. In the illustrated embodiment of FIG. 1, a relay agent may be present in the first router 140(1) for the first interface 112(1), and a relay agent may be present in the second router 140(2) for the third interface 112(3) of the multi-homed host 105.

As a general matter, to request the assignment of one or more IP addresses, the multi-homed host 105 first locates the server 110 on the network 125, and then requests the assignment of addresses and other configuration information from the server 110. In accordance with the DHCP, the multi-homed host 105, for a given interface, sends a SOLICIT message to the relay agent or servers to find available DHCP servers. Any server that can meet the multi-homed host's requirements responds with an ADVERTISE message. The multi-homed host 105 can choose from one of the servers (e.g., server 110, in the illustrated embodiment) and then send a REQUEST message to the server 110 asking for confirmed assignment of addresses and other configuration information. The server 110 responds with a REPLY message that contains the confirmed addresses and configuration information.

It should be appreciated that the arrangement of the communications system 100 of FIG. 1 is exemplary in nature and that, in alternative embodiments, the network 125 may include any desirable number of devices, including clients, such as the multi-homed host 105, that request addresses from the server 110. The communication system 100 may also include clients with a single interface 112. The multi-homed host 105 and server 110 may each be any suitable type of processor-based device, such as a desktop computer, laptop computer, a mainframe, a portable device, a kiosk, a Web appliance, and the like.

The various modules 130 and 135 illustrated in FIG. 1 are implemented in software, although in other implementations these modules may also be implemented in hardware or a combination of hardware and software. In one embodiment, each module 130 and 135 may comprise a plurality of modules, with each of the plurality of modules capable of performing one or more desired acts.

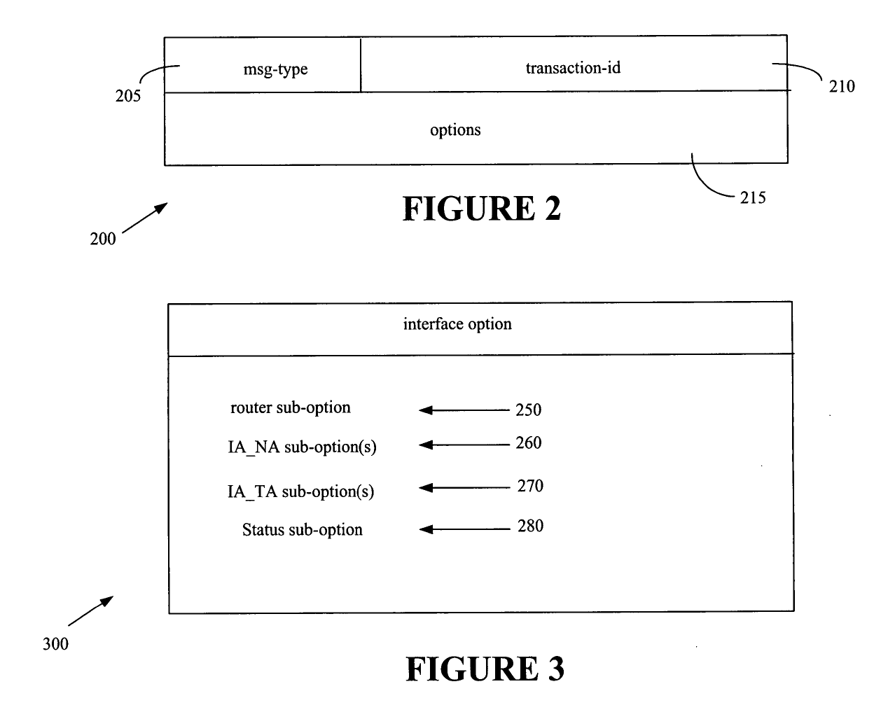

In the illustrated embodiment, as noted, the client module 130 of the multi-homed host 105 and the server module 135 of the server 110 communicate via DHCP messages. FIG. 2 illustrates a format of a DHCP message 200. As shown, the message 200 includes a msg-type field 205, a transaction-id field 210, and an options field 215. The msg-type field 205 identifies a DHCP message type (e.g., SOLICIT, ADVERTISE, REQUEST, etc.). The transaction-id field 210 refers to the transaction ID for the message exchange. The options field 215 refers to one or more options carried in the message, where the options are used to carry appropriate information and parameters in the DHCP message 200. In accordance with one embodiment of the present invention, a new option, referred to as “interface” option 300 (shown in FIG. 3), is defined that may be carried in the options field 215 of the message 200 of FIG. 2. The interface option 300, as explained below, allows the multi-homed host 105 to efficiently configure more than one interface 112.

FIG. 3 depicts exemplary contents of the interface option 300, which, as noted, may be transported in the options field 215 of the message 200 of FIG. 2. Those skilled in the art will appreciate that the contents of the interface option 300 may be formatted in any desirable format, including a format that is consistent with the format of various options described in RFC 3315 for the DHCP. Although not shown, the interface option 300, in one embodiment, may include a “code” field that identifies the specific option type carried in this option and a “length” field that specifies the length of the data in this option.

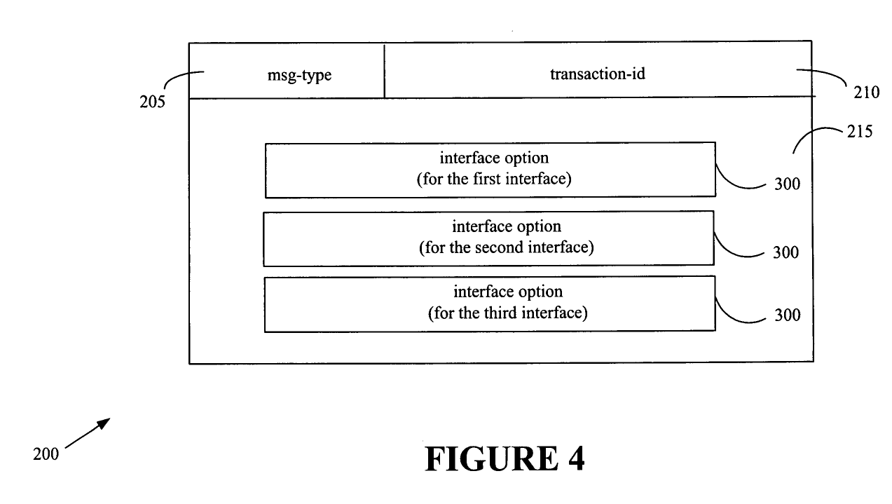

The interface option 300 of FIG. 3 includes various sub-options for carrying a variety of configuration information for a given interface 112. In accordance with one embodiment of the present invention, the multi-homed host 105 may include multiple interface options 300 in the message 200, one for each interface 112 to be configured. Thus, for example, if the multi-homed host 105 desires to configure all three interfaces 112(1-3), the client module 130 may include three interface options 300 (one for each interface 112) in the message 200, as shown in FIG. 4.

In the illustrated embodiment, the interface option 300 includes a router sub-option 250 for storing the “global” address of the router 140 associated with a given interface 112. The router 140 may be “associated” with a given interface 112 if, for example, the router 140 and that interface 112 share the same prefix (or are in the same subnet) or, for example, the router 140 and the interface 112 are attached to the same communication link. In the illustrated example of the communications system 100 of FIG. 1, the first router 140(1) is associated with the first interface 112(1) and the second router 140(2) is associated with the third interface 112(3). In some instances, the interface 112 may not have an associated router, as is the case with the second interface 112(2) of the multi-homed host 105. In FIG. 1, the second interface 112(2) is directly coupled to the server 110, for illustrative purposes.

The interface option 300 of FIG. 3 includes one or more IA_NA sub-options 260 that carry an Identity Association (IA), Non-temporary Address (NA), parameters associated with the IA_NA, and the non-temporary addresses associated with the IA_NA. An Identity Association (IA) is a collection of addresses assigned to a client, such as the multi-homed host 105. Each IA has an associated IAID, which is chosen by the multi-homed host 105 and is unique among all IAIDs for IAs belonging to that client. The multi-homed host 105 may have more than one IA assigned to it; for example, one for each of its interfaces 112(1-3). Each IA can hold one type of address: non-temporary addresses (NA) or temporary addresses (TA).

The interface option 300 may also include one or more IA_TA sub-options 270 that carry Identity Association (IA), Temporary Address (TA), parameters associated with the IA_TA, and the addresses associated with the IA_TA. In one embodiment, the IA_NA and IA_TA sub-options 310, 315 may be similar or identical to the OPTION_IA_NA and OPTION_IA_TA, respectively, defined in RFC 3315 for the DHCP.

The interface option 300 may also include a status sub-option 280 to allow the server to indicate if the server 110 will allow or deny the group of addresses specified in the interface option 300. Thus, in one embodiment, the status sub-option 280 can be utilized to efficiently deny or allow all of the requested addresses at an interface-level.

While the present invention defines a new option, interface option 300, for the Dynamic Host Configuration Protocol, in an alternative embodiment, instead of defining a new option, one or more of the existing options in the DHCP may be modified to convey some or all of the information associated with the interface option 300 of FIG. 3.

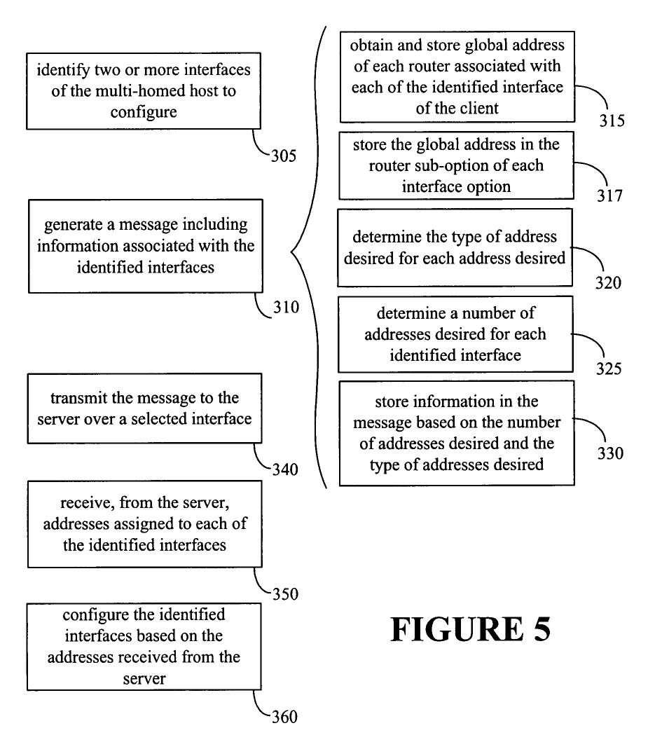

Referring now to FIG. 5, a flow diagram of one aspect of the client module 130 of FIG. 1 is illustrated, in accordance with one embodiment of the present invention. For ease of illustration, the flow diagram of the client module 130 is discussed in the context of the communications system 100 of FIG. 1. The module 130 identifies (at 305) two or more interfaces 112(1-3) of the multi-homed host 105 to configure. For illustrative purposes, it is assumed that the client module 130 desires to configure all three interfaces 112(1-3) based on addresses provided by the server 110.

The client module 130 generates (at 310) a message including information associated with the identified interfaces 112(1-3) for delivery to the server 110. In one embodiment, the message generated (at 310) takes the form of the DHCP message 200 shown FIG. 2. In such an embodiment, the message generated (At 310) can be a SOLICIT message. Accordingly, the msg-type field 205 of the message 200 can be utilized to indicate that the message type is a SOLICIT message. And, in the options field 215, the client module 130 stores three interface options 300 of FIG. 3, one for each interface 112. In one embodiment, as part of generating (at 310) the message, the client module 130 obtains (at 315) the global address of the router 140 associated with each of the interface 112 to be configured. For example, with respect to the first interface 112(1), the module 130 obtains (at 315) the global address of the first router 140(1). Similarly, with respect to the third interface 112(3), the client module 130 obtains (at 315) the global address of the second router 140(2). In one embodiment, the global address of a router 140 may be determined using the Neighbor Discovery Protocol.

The global address of the router 140 associated with a given interface 112 is stored (at 317) in the router sub-option 250 of each interface option 300. Thus, because the first interface 112(1) is associated with the first router 140(1) in the illustrated example of FIG. 1, the client module 130 stores (at 317) the global address of the first router 140(1) in the router sub-option 250 of the interface option 300 associated with the first interface 112(1). Similarly, because the third interface 112(3) is associated with the second router 140(2) in the illustrated example of FIG. 1, the client module 130 stores (at 317) the global address of the second router 140(2) in the router sub-option 250 of the interface option 300 associated with the third interface 112(3) of the multi-homed host 105.

The client module 130 determines (at 320) a type of address (e.g., non-temporary address and/or temporary address) desired for each identified interface 112 and determines (at 325) a number of addresses desired for each type of address. For example, it may be determined (at 320) that a non-temporary address (NA) type is desired for the first interface 112(1), and may be further determined (at 325) that two of this type of address are desired for the first interface 112(1). As another example, it may be determined (at 320 and 325) that one non-temporary address (NA) and one temporary address (TA) are desired for the third interface 112(3). Based on the type and number of addresses desired, the client module 130 stores (at 330) the appropriate information in the interface option 300 of the message 200. In particular, if a non-temporary address is desired, the client module 130 may utilize the IA_NA sub-option 260 to indicate that a non-temporary address is required for a given IAID. If a temporary address is desired, the client module 130 may utilize the IA_TA sub-option 270 to indicate that a temporary address is required for a given IAD. If more than one IA_NA or IA_TA is desired, the client module 130 may include an additional number of IA_NA or IA_TA sub-options 310, 315 in the interface option 300 for each additional address desired.

Upon generating the message (at 310), the client module 130 transmits (at 340) the message to the server 110 over a selected interface 112. The manner in which a particular interface 112 is selected by the client module 130 over which the message is transmitted may vary from one implementation to another. In the illustrated embodiment, because the second interface 112(2) and the server 110 share the same prefix, the second interface 112(2) is chosen as the interface over which the message is transmitted. The server 110, upon receiving the transmitted message, processes the information conveyed in each of the three interface options 300 of the message 200. In particular, the server 110 processes the IA options designated in the interface option 300 for the first interface 112(1), and further verifies the subnet (or prefix) on which the first interface 112(1) resides based on the global address provided in the router sub-option 250 of that interface option 300. Similarly, the server 110 processes the information conveyed in the interface option 300 for the other interfaces 112(2-3). Thereafter, the server 110 proceeds in the usual manner according to the DHCP, where the server 110 returns addresses for each of the IAs specified in the message 200.

The client module 130 receives (at 350), from the server 110, addresses assigned to each of the identified interfaces 112(1-3). Thereafter, the client module 130 configures (at 360) the identified interfaces 112(1-3) based on the addresses received from the server 110. In view of the aforementioned description, the client module 130 is able to efficiently configure a plurality of interfaces 112(1-3) by transmitting a request for IP addresses for a plurality of interfaces 112(1-3) in a DHCP message. As such, the amount of duplicative information that would ordinarily be carried in separate requests for addresses can now be reduced with the advent of one or more embodiments of the present invention.

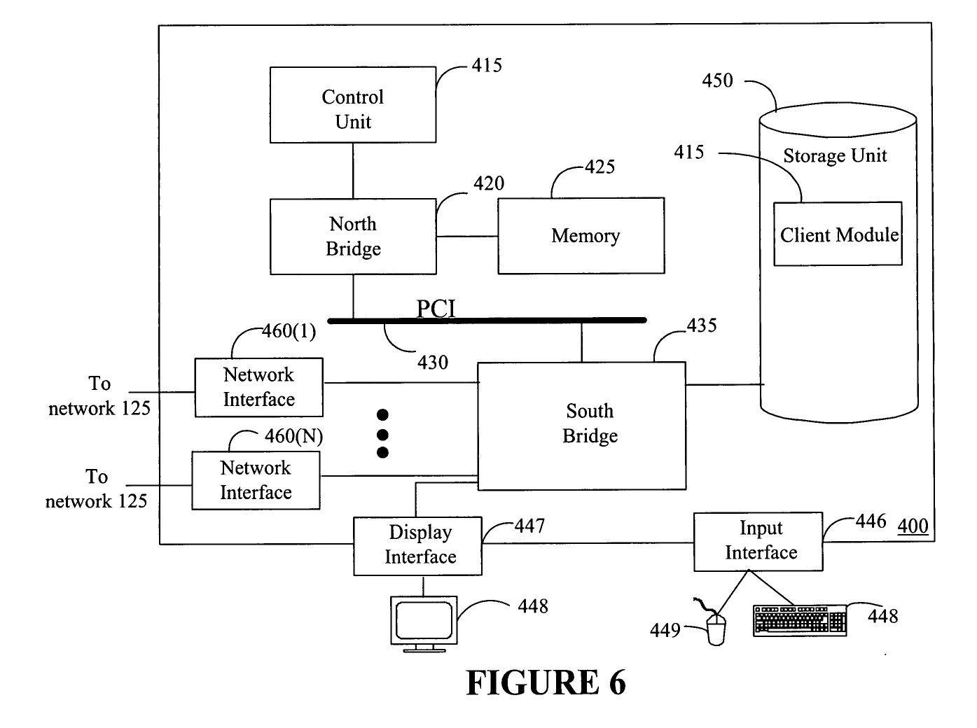

Referring now to FIG. 6, a stylized block diagram of a processor-based device 400 that may be implemented in the communications system of FIG. 1 is illustrated, in accordance with one embodiment of the present invention. That is, the processor-based device 400 may represent one embodiment of the multi-homed host 105. The processor-based device 400 comprises a control unit 415, which in one embodiment may be a processor that is capable of interfacing with a north bridge 420. The north bridge 420 provides memory management functions for a memory 425, as well as serves as a bridge to a peripheral component interconnect (PCI) bus 430. In the illustrated embodiment, the processor-based device 400 includes a south bridge 435 coupled to the PCI bus 430.

A storage unit 450 is coupled to the south bridge 435. The client module 130 may be storable in the storage unit 450, and can be executable by the control unit 415. Although not shown, it should be appreciated that in one embodiment an operating system, such as Windows®, Disk Operating System®, Unix®, OS/2®, Linux®, MAC OS®, or the like, may be stored on the storage unit 450 and executable by the control unit 415. The storage unit 450 may also include device drivers for the various hardware components of the processor-based device 400.

In the illustrated embodiment, the processor-based device 400 includes a display interface 447 that is coupled to the south bridge 435. The processor-based device 400 may display information on a display device 448 via the display interface 447. The south bridge 435 of the processor-based device 400 may include a controller (not shown) to allow a user to input information using an input device, such as a keyboard 448 and/or a mouse 449, through an input interface 446.

The south bridge 435 of the processor-based device 400, in the illustrated embodiment, is coupled to one or more network interfaces 460(1-N), which may be adapted to receive, for example, local area network cards. The processor-based device 400 communicates with other devices coupled to the network 125 through the network interfaces 460(1-N). Although not shown, associated with the network interface 460(1-N) may be a network protocol stack, with one example being a UDP/IP (User Datagram Protocol/Internet Protocol) stack. In one embodiment, both inbound and outbound packets may be passed through the network interface 460(1-N) and the network protocol stack.

In one embodiment, the processor-based device 400 may also represent the server 110 of FIG. 1. As such, the server module 135 may be stored in the storage unit 450 of the processor-based device 400. In one embodiment, if the processor-based device 400 is implemented as the server 110, the client module 130 may or may not be stored in the storage unit 450. Additionally, the processor-based device 400 may include, if desired, a single network interface 460 instead of a plurality of interfaces 460(1-N).

It should be appreciated that the configuration of the processor-based device 400 of FIG. 6 is exemplary in nature and that, in other embodiments the processor-based device 400 may include fewer, additional, or different components without deviating from the spirit and scope of the present invention. For example, in an alternative embodiment, the processor-based device 400 may not include a north bridge 420 or a south bridge 435, or may include only one of the two bridges 420, 435, or may combine the functionality of the two bridges 420, 435. As another example, in one embodiment, the processor-based device 400 may include more than one control unit 415. Similarly, other configurations may be employed consistent with the spirit and scope of the present invention.

The various system layers, routines, or modules may be executable control units (such as control unit 415 (see FIG. 6)). The control unit 415 may include a microprocessor, a microcontroller, a digital signal processor, a processor card (including one or more microprocessors or controllers), or other control or computing devices. The storage devices 450 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices 450. The instructions when executed by a respective control unit 415 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
generating a message, the message including a request for a server to provide a first address to assign to a first interface of a client device and a second address to assign to a second interface of the client device;
transmitting the message to the server over a communication link;
receiving a response from the server, the response including the first address and the second address; and
configuring at least one of the first interface and second interface based on the response received from the server.

2. The method of claim 1, wherein the first interface and the second interface are each a network adapter, and wherein generating the message comprises:
determining a global address of a router associated with at least one of the first interface and the second interface;
storing a value representative of the global address of the router in the message;
determining a type of address desired for at least one of the first interface and second interface; and
storing the type of address desired in the message.

3. The method of claim 2, wherein the message type may be one of a temporary address and a non-temporary address, wherein generating the message comprises determining a number of addresses desired for each type of address and storing the number of addresses desired for each type of address in the message.

4. The method of claim 1, wherein transmitting the message comprises transmitting the message using at least one of the first interface and the second interface to the server over the communication link.

5. The method of claim 1, wherein the act of configuring comprises assigning the first address to the first interface and the second address to the second interface and wherein determining the global address of the router comprises determining the global address using the Neighbor Discovery Protocol.

6. The method of claim 1, wherein the server is a Dynamic Host Configuration Protocol (DHCP) server, and wherein receiving the response from the server comprises receiving a DHCP message from the DHCP server.

7. An article comprising one or more machine-readable storage media containing instructions that when executed enable a processor to:
generate a message requesting a server to provide a first address to assign to a first interface of a client device and a second address to assign to a second interface of the client device;
transmit the message to the server;
receive a response from the server, the response including the first address and the second address; and
configure at least one of the first interface and second interface based on the response received from the server.

8. The article of claim 7, wherein the instructions when executed enable the processor to:
determine a global address of a router associated with at least one of the first interface and the second interface;
store a value representative of the global address of the router in the message;
determine a type of address desired for at least one of the first interface and second interface; and
store the type of address desired in the message.

9. The article of claim 7, wherein the instructions when executed enable the processor to determine a number of addresses desired for each type of address and store the number of addresses desired for each type of address in the message.

10. The article of claim 7, wherein the instructions when executed enable the processor to transmit the message using at least one of the first interface and the second interface to the server.

11. The article of claim 7, wherein the instructions when executed enable the processor to assign the first address to the first interface and the second address to the second interface.

12. A client device, comprising:
at least a first interface and a second interface; and
a control unit adapted to:
generate a message requesting a server to provide a first address to assign to the first interface of a client device and a second address to assign to the second interface of the client device;
transmit the message to the server;
receive a response from the server, the response including the first address and the second address; and
configure at least one of the first interface and second interface based on the response received from the server.

13. The client device of claim 12, wherein the control unit is adapted to:
determine a global address of a router associated with at least one of the first interface and the second interface;
store a value representative of the global address of the router in the message;
determine a type of address desired for at least one of the first interface and second interface; and
store the type of address desired in the message.

14. The client device of claim 12, wherein the control unit adapted to configure comprises the control unit adapted to assign the first address to the first interface and the second address to the second interface.

15. The client device of claim 12, wherein the server is a Dynamic Host Configuration Protocol (DHCP) server, and wherein receiving the response from the server comprises receiving a DHCP message from the DHCP server.

16. The client device of claim 12, wherein the first interface and the second interface are each a network adapter.

17. A server, comprising:
an interface; and
a control unit communicatively coupled to the interface, the control unit adapted to:
receive a message from a client, the message including a request to provide a first address for assignment to a first interface of the client and a second address for assignment to a second interface of the client; and
transmit a response to the client, the response including the first address and the second address.

18. The server of claim 17, wherein the control unit adapted to transmit a message comprises the control unit adapted to transmit a Dynamic Host Configuration Protocol (DHCP) message.

19. The server of claim 17, wherein the control unit is adapted to provide in the response multiple addresses for the first interface.

20. The server of claim 17, wherein the interface is a network adapter.

21. A message structure for conveying information between a client and a server, comprising:
a first field for identifying a type of message; and
a second field including:
a first interface option for providing configuration information associated with a first interface of a client, the configuration information including a type of address desired for the first interface; and
a second interface option for providing configuration information associated with a second interface of the client, the configuration information including a type of address desired for the second interface.

22. The message structure of claim 21, wherein the first interface option and the second interface option each further includes configuration information associated with a number of addresses desired for the type of address chosen.

23. The message structure of claim 21, wherein the type of address desired comprises at least one of non-temporary address and temporary address.

24. The message structure of claim 21, wherein the first interface option further includes configuration information regarding router information associated with the first interface of the client and the wherein the second interface option further includes configuration information regarding router information associated with the second interface of the client.

25. The message structure of claim 21, further including a third field for a transaction identifier and wherein the first interface option further includes information associated with a status of the first interface of the client device.
